(19) United States
(12) Patent Application Publication
(10) Pub. No.: US 2026/0203996 A1
(43) Pub. Date: Jul. 16, 2026

(54) Neural Radiance Field Models with Improved Robustness Against Distractor Objects

(71) Applicant: Google LLC, Mountain View, CA (US)

(72) Inventors: Daniel Christopher Duckworth, Berlin (DE); Sara Sabour Rouh Aghdam, Toronto (CA); Ivan Mikhaylovich Krasin, Mountain View, CA (US); Andrea Tagliasacchi, Victoria (CA); David James Fleet, Toronto (CA); Suhani Deepak-Ranu Vora, San Mateo, CA (US)

(21) Appl. No.: 19/135,755

(22) PCT Filed: Dec. 7, 2023
(86) PCT No.: PCT/US2023/082869

§ 371 Date: Jun. 4, 2025

Related U.S. Application Data
(60) Provisional application No. 63/430,847, filed on Dec. 7, 2022.

(51) Int. Cl. G06T 15/20; G06T 5/70; G06T 15/08; G06V 10/56

(52) U.S. Cl. CPC G06T 15/20; G06T 5/70; G06T 15/08; G06V 10/56

(57) ABSTRACT

A central problem in training NeRF models is addressed, namely, optimization in the presence of distractors, such as transient or moving objects and photometric phenomena that are not persistent throughout the capture session. Example techniques formulate training as a form of iteratively re-weighted least squares, with a variant of trimmed LS, and an inductive bias on the smoothness of the outlier process.

### PRIORITY CLAIM

The resent application is based on and claims priority to U.S. Provisional Application 63/430,847 having a filing date of Dec. 7, 2022, which is incorporated by reference herein.

### FIELD

The present disclosure relates generally to machine learning. More particularly, the present disclosure relates to the use of an iteratively reweighted least-squares loss function to generate neural radiance field (NeRF) models that demonstrate improved robustness against distractors.

### BACKGROUND

The ability to understand the structure of a static 3D scene from 2D images alone is a fundamental problem in computer vision. It finds applications in AR/VR for mapping virtual environments, in autonomous robotics for action planning, and in photogrammetry to create digital copies of real-world objects.

Neural fields have recently revolutionized this classical task, by storing 3D representations within the weights of a neural network. These representations are typically optimized by back-propagating image differences. When the fields store view-dependent radiance and volumetric rendering is employed, 3D scenes can be captured with photo-realistic accuracy. The generated representation stored as weights of a neural network or other machine learning model can be referred to as a neural radiance field, or NeRF.

Training of NeRF models generally requires a large collection of images equipped with accurate camera calibration, which can often be recovered via structure-from-motion. Behind its simplicity, NeRF hides several assumptions. As models are typically trained to minimize error in RGB color space, it is of paramount importance that images are photometrically consistent-two photos taken from the same vantage point or position should be identical up to noise. Unless one employs a method explicitly accounting for such variations, one should manually hold a camera's focus, exposure, white-balance, and ISO fixed.

However, properly configuring one's camera is not all that is required to capture high-quality NeRFs—it is also important to avoid distractors. The term “distractors” refers to anything that is not persistent throughout the entire capture session. Distractors come in many shapes and forms, from the hard-shadows cast by the operators as they explore the scene to a pet or child casually walking within the camera's field of view. Distractors are tedious to remove manually, as this would require pixel-by-pixel labeling. They are also tedious to detect, as typical NeRF scenes are trained from hundreds of input images, and the types of distractors are not known a priori. If distractors are ignored, the quality of the reconstruction scene suffers significantly.

In a typical capture session, one does not have the ability to capture multiple images of the same scene from the same vantage point or position, rendering distractors challenging to model mathematically. More specifically, while view-dependent effects are what give NeRF their realistic look, it can be challenging for the model to tell the difference between a distractor and a view-dependent effect of the static scene.

Thus, existing approaches for neural radiance fields excel at synthesizing new views given multi-view, calibrated images of a static scene. However, when scenes include distractors, which are not persistent during image capture (moving objects, lighting variations, shadows), artifacts often appear as view-dependent effects or “floaters”. Although various approaches have been proposed to improve robustness against distractors, each of such approaches has significant drawbacks.

### SUMMARY

Aspects and advantages of embodiments of the present disclosure will be set forth in part in the following description, or can be learned from the description, or can be learned through practice of the embodiments.

One example aspect of the present disclosure is directed to a computer-implemented method to train a neural radiance field model to generate synthetic imagery of a scene. The method includes: for each of one or more of a plurality of training iterations: obtaining a position within three-dimensional space; processing data descriptive of the position with the neural radiance field model to generate a synthetic pixel color at a pixel location in a synthetic image that depicts the scene from the position; evaluating a loss function that compares the synthetic pixel color with a ground truth pixel color at the pixel location in a training image that depicts the scene from the position, wherein the loss function comprises an iteratively reweighted least-squares function that comprises a weighting function that assigns a final weight to a residual associated with the pixel location based at least in part on intermediate weights assigned to one or more neighboring pixel locations in a neighborhood surrounding the pixel location; and modifying one or more parameter values for one or more parameters of the neural radiance field model based at least in part on the loss function.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts a block diagram of an example process for training a machine-learned view synthesis model and then using the machine-learned view synthesis model to perform view synthesis according to example embodiments of the present disclosure.

FIG. 2 depicts a block diagram of an example process to train a machine-learned view synthesis model according to example embodiments of the present disclosure.

FIG. 3 depicts a block diagram of an example process to use a machine-learned view synthesis model according to example embodiments of the present disclosure.

FIG. 4 depicts a flow chart diagram of an example method to perform training of a NeRF model according to example embodiments of the present disclosure.

FIG. 5A depicts a block diagram of an example computing system according to example embodiments of the present disclosure.

FIG. 5B depicts a block diagram of an example computing device according to example embodiments of the present disclosure.

FIG. 5C depicts a block diagram of an example computing device according to example embodiments of the present disclosure.

Reference numerals that are repeated across plural figures are intended to identify the same features in various implementations.

### DETAILED DESCRIPTION

### Overview

Generally, the present disclosure is directed to systems and methods that use an iteratively reweighted least-squares loss function to generate neural radiance field models that demonstrate improved robustness against distractors. In particular, to cope with distractors, example implementations of the present disclosure perform a form of robust estimation for NeRF training that models distractors in training data as outliers of an optimization problem. The proposed methodology successfully removes outliers from a scene and improves upon the state-of-the-art for both synthetic and real-world scenes. The proposed technique is simple to incorporate in modern frameworks, with few hyper-parameters. It does not assume a priori knowledge of the types of distractors but is instead focused on the optimization problem rather than pre-processing or modeling transient objects.

More particularly, certain approaches for neural radiance fields excel at synthesizing new views given multi-view, calibrated images of a static scene. However, when scenes include distractors, which are not persistent during image capture (moving objects, lighting variations, shadows), artifacts often appear as view-dependent effects or “floaters”. Although various approaches have been proposed to improve robustness against distractors, each of such approaches has significant drawbacks.

Specifically, several approaches attempt to improve robustness against distractors. As one proposed approach, if distractors are known to belong to a specific class (e.g., people), one can remove them with a pre-trained semantic segmentation model. However, this process does not generalize to “unexpected” distractors such as shadows. In another proposed approach to handle distractors, one can model distractors as per-image transient phenomena and control the balance of transient/persistent modeling. However, it is difficult to tune the losses that control this Pareto-optimal objective. In another proposed approach, one can model data in time (e.g., high-framerate video) and decompose the scene into static and dynamic (e.g., distractor) components. However, this approach is clearly limited to video rather than photo collection captures.

In contrast to the approaches described above, example implementations of the present disclosure approach the problem of distractors by modeling them as outliers in NeRF optimization. In particular, example implementations of the present disclosure approach the problem of removing dynamic elements of a scene by treating them as outliers in a robust optimization setting. Since reconstructing the pixels attributed to outliers will always have a greater loss compared to the consistent regions of an image, a robust optimization is able to ignore the inconsistent pixels. Therefore, example implementations can render a clean scene out of a series of images with moving objects without requiring extra modeling capacity.

Furthermore, utilizing a robust optimizer rather than modeling the dynamic parts increases the versatility of the proposed technique. For example, then a training approach aims to directly model the dynamic parts of a scene, the number of dynamic parts is inherently limited by the capacity of the model. On the other hand, the proposed approach enables the model to simply ignore the dynamic parts or other distractors. As such, there can be a completely different set of objects in each image and it would be no different from the perspective of a robust optimizer.

With reference now to the Figures, example embodiments of the present disclosure will be discussed in further detail.

### Example Overview of Neural Radiance Fields

A neural radiance field (NeRF) is a continuous volumetric representation of a 3D scene, stored within the parameters of a neural network. The representation maps a position and view direction to a view-dependent RGB color and view-independent density:

$$\begin{matrix}c ( x , d ) \\ σ ( x )\end{matrix} \} f ( x , d ; θ ) \qquad ( 1 )$$

This representation is trained from a collection, {(Cᵢ, Tᵢ)}, of images Cᵢ with corresponding calibration parameters Tᵢ (e.g., camera extrinsics and intrinsics).

During training the calibration information is employed to convert each pixel of the image into a ray r=(o,d), and rays are drawn randomly from input images to form a training mini-batch (r~Cᵢ). The parameters θ are typically optimized to correctly predict the colors of the pixels in the batch via the L2 photometric-reconstruction loss:

$${ℒ}_{rgb} ( θ ) = {\sum }_{i} {𝔼}_{r - {C}_{i}} [ {ℒ}_{rgb}^{r , i} ( θ ) ] \qquad ( 2 )$$

$${ℒ}_{rgb}^{r , i} ( θ ) = {‖ C ( r ; θ ) - {C}_{t} ( r ) ‖}_{2}^{2} \qquad ( 3 )$$

Parameterizing the ray as r(t)=o+td, the NeRF model image C(r; θ) can be generated pixel-by-pixel via volumetric rendering based on σ(·) and c(·).

### Example Techniques to Improve NeRF Robustness

Certain existing NeRF training losses are effective for capturing scenes that are photometrically consistent, leading to the photo-realistic novel-view synthesis that we are now accustomed to seeing in recent research. However, these techniques demonstrate poor performance when there are elements of the scene that are not persistent throughout the entire capture session. Simple examples of such scenes include those in which an object is only present in some fraction of the observed images, or may not remain in the same position in all observed images. For video capture and spatio-temporal NeRF models, the persistent objects comprise the “static” portion of the scene, while the rest would be called the “dynamic”.

### Example Discussion of Sensitivity to Outliers

For Lambertian scenes, photo-consistent structure is view independent, as scene radiance only depends on the incident light. For such scenes, view-dependent NeRF models often admit local optima in which transient objects are explained by view-dependent terms. Such models exploit the view-dependent capacity of the model to over-fit observations, effectively memorizing the transient objects. One can alter the model to remove dependence on d, but the L2 loss remains problematic as least-squares (LS) estimators are sensitive to outliers, or heavy-tailed noise distributions.

Under more natural conditions, dropping the Lambertian assumption, the problem becomes more complex as both non-Lambertian reflectance phenomena and outliers can be explained as view-dependent radiance. While we want the models to capture photo-consistent view-dependent radiance, outliers and other transient phenomena should ideally be ignored. And in such cases, optimization with an L2 loss yields significant errors in reconstruction. Problems like these are pervasive in NeRF model fitting, especially in uncontrolled environments with complex reflectance, non-rigidity, or independently moving objects.

### Example Discussion of Robustness to Outliers

### Robustness Via Semantic Segmentation

One way to reduce outlier contamination during NeRF model optimization is to rely on an oracle that specifies whether a given pixel from image i is an outlier, and should therefore be excluded from the empirical loss, replacing the conventional L2 loss with:

$${ℒ}_{oracle}^{r , i} ( θ ) = {S}_{i} ( r ) \cdot {‖ C ( r ; θ ) - {C}_{i} ( r ) ‖}_{2}^{2} \qquad ( 4 )$$

In practice, a pre-trained (semantic) segmentation network might be used as an oracle, Sᵢ= [symbol] (Cᵢ). For example, Nerf-in-the-wild employed a semantic segmenter to remove pixels occupied by people, as they represent outliers in the context of photo-tourism. Urban Radiance Fields segmented out sky pixels, while LOL-NeRF ignored pixels not belonging to faces. The obvious problem with this approach is the need for an oracle that detects outliers for arbitrary distractors.

### Robust Estimators

Another way to reduce sensitivity to outliers is to replace the conventional L2 loss with a robust loss, so that photometrically-inconsistent observations can be down-weighted during optimization. Given a robust kernel [symbol] (·), we rewrite our training loss as:

$${ℒ}_{robust}^{r , i} ( θ ) = 𝒦 ( {‖ C ( r ; θ ) - {C}_{i} ( r ) ‖}_{2}^{2} ) \qquad ( 5 )$$

where [symbol] (·) is positive and monotonically increasing. Given our analysis, a valid question is whether we can straightforwardly employ a robust kernel to approach our problem, and if so, given the large variety of robust kernels, which is the kernel of choice.

Unfortunately, as discussed above, outliers and non-Lambertian effects can both be modelled as view-dependent effects. As a consequence, with simple application of robust estimators it can be difficult to separate signal from noise. For example, in some approaches outliers are removed, but fine-grained texture and view-dependent details are also lost, or conversely, fine-grained details are preserved, but outliers cause artifacts in the reconstructed scene. One can also observe mixtures of these cases in which details are not captured well, nor are outliers fully removed. We find that this behavior occurs consistently for many different robust estimators and parameter settings.

Training time can also be problematic. The robust estimator gradient w.r.t. model parameters can be expressed using the chain rule as

$$\frac{\partial 𝒦 ( ϵ ( θ ) )}{\partial θ} {\vert}_{{θ}^{( t )}} = \frac{\partial 𝒦 ( ϵ )}{\partial ϵ} {\vert}_{ϵ ( {θ}^{( t )} )} \cdot \frac{\partial ϵ ( θ )}{\partial θ} {\vert}_{{θ}^{( t )}} \qquad ( 6 )$$

The second factor is the classical NeRF gradient. The first factor is the kernel gradient evaluated at the current error residual ∈(θ^{(t)}). During training, large residuals can equivalently come from high-frequency details that have not yet been learnt, or they may arise from outliers. This explains why robust optimization, e.g., implemented as (5), should not be expected to decouple high-frequency details from outliers. Further, when strongly robust kernels are employed, like redescending estimators, this also explains the loss of visual fidelity. That is, because the gradient of (large) residuals get down-weighted by the (small) gradients of the kernel, slowing down the learning of these fine-grained details.

### Example Approaches for Robustness Via Trimmed Least Squares

The section that follows describes a novel form of iteratively reweighted least-squares (IRLS) with a Trimmed least squares (LS) loss for NeRF model fitting.

### Iteratively Reweighted Least Squares

IRLS is a method for robust estimation that involves solving a sequence of weighted LS problems, the weights of which are adapted to reduce the influence of outliers. To that end, at iteration t, one can write the loss as

$${ℒ}_{robust}^{r , i} ( θ ) = ω ( {ϵ}^{( t - 1 )} ( r ) ) \cdot {‖ C ( r ; {θ}^{( t )} ) - {C}_{i} ( r ) ‖}_{2}^{2} \qquad ( 7 )$$

$${ϵ}^{( t - 1 )} ( r ) = {‖ C ( r ; {θ}^{( t - 1 )} ) - {C}_{i} ( r ) ‖}_{2}$$

For weight functions given by ω(∈)=∈⁻¹·∂ [symbol] (∈)/∂∈ one can show that, under suitable conditions, the iteration converges to a local minima of (5).

This framework admits a broad family of losses, including maximum likelihood estimators for heavy-tailed noise processes. Examples include the Charbonnier loss (smoothed L1), and more aggressive redescending estimators such as the Lorentzian or Geman-McClure.

Nevertheless, choosing a suitable weight function ω(∈) for NeRF optimization is non-trivial, due in large part to the intrinsic ambiguity between view-dependent radiance phenomena and outliers. One might try to solve this problem by learning a neural weight function, although generating enough annotated training data might be prohibitive. Instead, one example approach taken in this section is to exploit inductive biases in the structure of outliers, combined with the simplicity of a robust, trimmed LS estimator.

### Trimmed Robust Kernels

One goal is a weight function for use in iterative weighted LS optimization that is simple and captures useful inductive biases for NeRF optimization. For simplicity example implementations opt for a binary weight function with intuitive parameters that adapts naturally through model fitting so that fine-grained image details that are not outliers can be learned quickly. It is also important to capture the structured nature of typical outliers, contrary to the typical i.i.d. assumption in most robust estimator formulations. To this end some example weight functions will capture spatial smoothness of the outlier process, recognizing that objects typically have continuous local support, and hence outliers are expected to occupy large and connected regions of an image (e.g., the silhouette of a person to be segmented out from a photo-tourism dataset).

An example weight function that embodies these properties and performs extremely well in practice is described herein. The weight function is based on so-called trimmed estimators that are used in trimmed least-squares. Example implementations first sort residuals, and assume that residuals below a certain percentile are inliers. As an example, picking the 50% percentile for convenience (i.e., median), some example implementations assign an intermediate weight value as follows:

$$\tilde{ω} ( r ) = ϵ ( r ) \leq {T}_{ϵ} , {T}_{ϵ} = {Median}_{r} \{ ϵ ( r ) \} . \qquad ( 8 )$$

To capture spatial smoothness of outliers, some example implementations optionally further spatially diffuse inlier/outlier labels with a smoothing kernel, such as, e.g., a 3×3 box kernel [symbol] _{3×3}. Formally, some example implementations assign smoothed weight values as follows:

$$𝒲 ( r ) = ( \tilde{ω} ( r ) \text{?} {ℬ}_{3 \times 3} ) \geq {T}_{\text{?}} , {T}_{\text{?}} = 0.5 . \qquad ( 9 )$$

This tends to remove high-frequency details from being classified as outliers, allowing them to be captured by the NeRF model during optimization.

While the trimmed weight function (9) improves the robustness of model fitting, it can also result in some instances in misclassification of fine-grained texture details early in training where the NeRF model first captures coarse-grained structure. These localized texture elements may emerge but only after very long training times. We find that stronger inductive bias to spatially coherence allows fine-grained details to be learned more quickly. To that end, some example implementations aggregate the detection of outliers on 16×16 neighborhoods (other sizes can be used as well); e.g., some example implementations label entire 8×8 patches (other sizes can be used as well) as outliers or inliers based on the behavior of [symbol] in the 16×16 neighborhood of the patch. Formally, denoting the N×N neighborhood of pixels around r as [symbol] _{N}(r), some example implementations can assign a final weight value as follows:

$$ω ( {ℛ}_{8} ( r ) ) = {𝔼}_{s \sim {ℛ}_{16} ( r )} [ 𝒲 ( s ) ] \geq {T}_{ℛ} , {T}_{ℛ} = 0.6 . \qquad ( 10 )$$

Note that this robust weight function evolves during optimization, as one expects with IRLS where the weights are a function of the residuals at the previous iteration. That is, the labeling of pixels as inliers/outliers changes during training, and settles around masks similar to the one an oracle would provide as training converges.

### Example Model Configurations

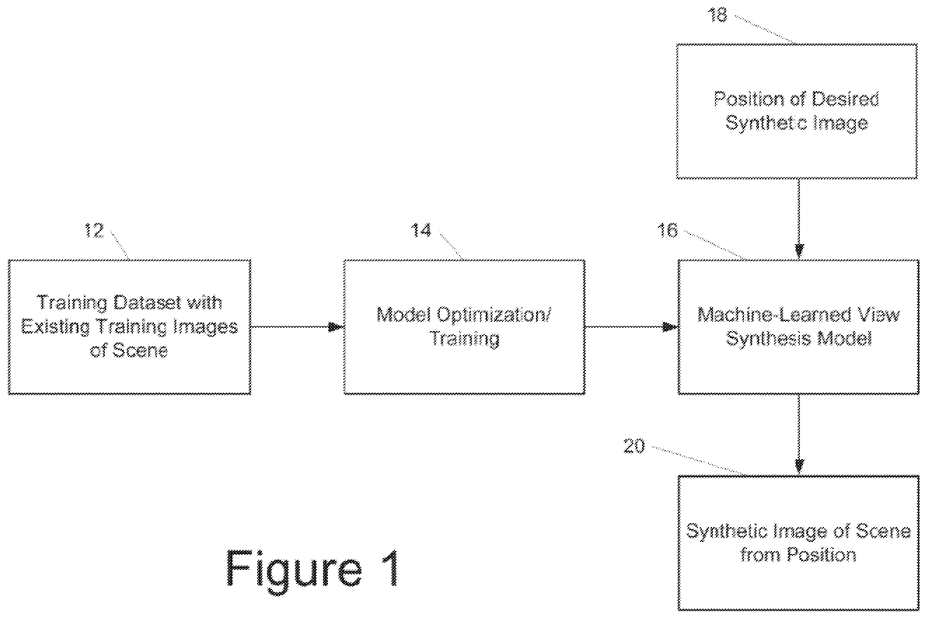

FIG. 1 depicts a block diagram of an example process for training a machine-learned view synthesis model and then using the machine-learned view synthesis model to perform view synthesis according to example embodiments of the present disclosure.

Referring to FIG. 1, a training dataset 12 can include existing training images that depict a scene (e.g., a synthetic scene or a real-world scene). In some example implementations, the training images can include (e.g., depict) distractors within the scene. For example, in some example implementations, the training images may be unconstrained and may exhibit various inconsistencies with each other.

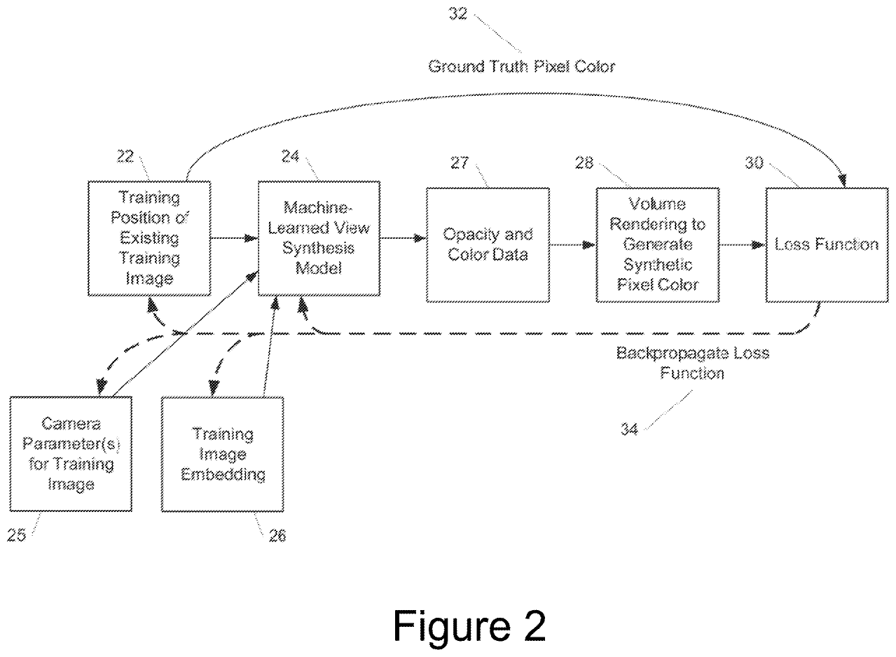

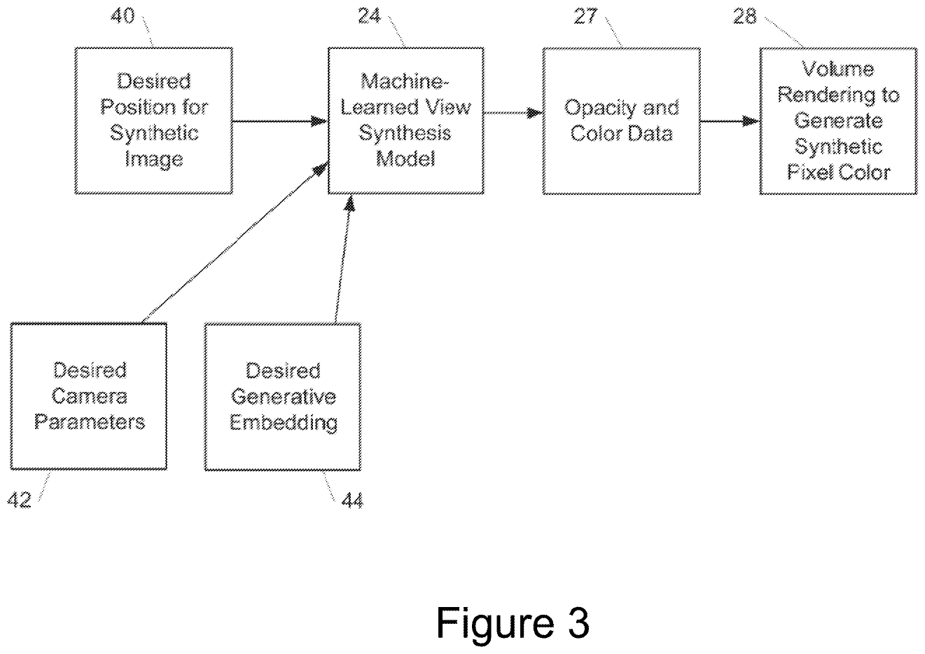

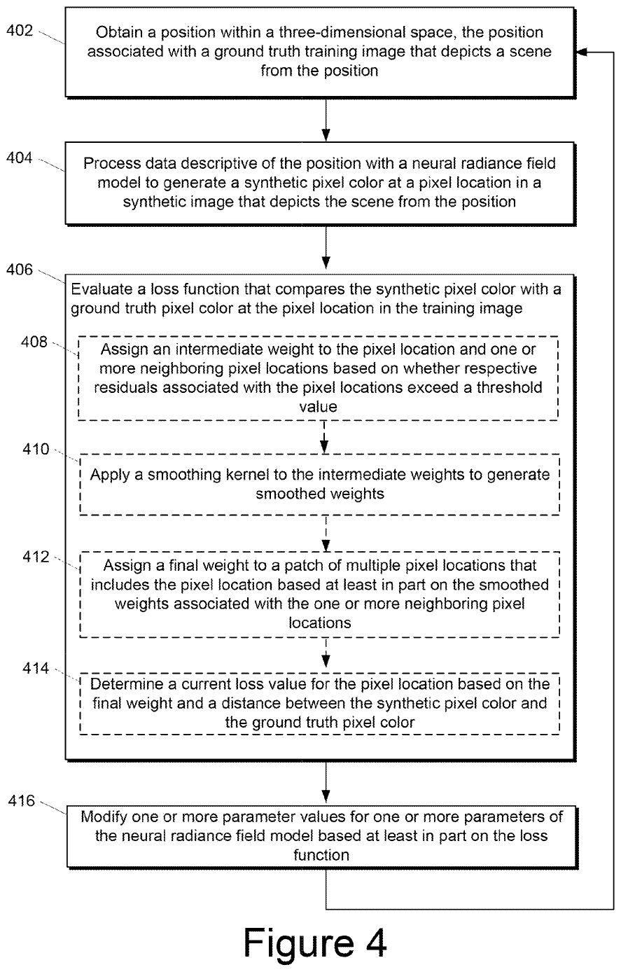

As shown at 14, a computing system can perform a model optimization or training process on the training dataset 12 to generate a machine-learned view synthesis model 16 (see, e.g., FIG. 2, FIG. 4, etc.). As used herein, a view synthesis model can be or include a NeRF model. After training, a position of a desired synthetic image 18 can be provided to the model 16. In response, the model 16 can generate a synthetic image 20 that depicts the scene from the position 18 (see, e.g., FIG. 3).

FIG. 2 depicts a block diagram of an example process to train a machine-learned view synthesis model according to example embodiments of the present disclosure. In some implementations, the process shown in FIG. 2 can be performed for each pixel of each training image.

Referring to FIG. 2, a training position 22 of an existing training image can be provided to the machine-learned view synthesis model 24. The position 22 can include a location and orientation of the camera that took the training image. In addition, optionally, in some implementations, one or more camera parameters 25 for the training image and/or a training image embedding 26 for the training image can be provided to the machine-learned view synthesis model 24. As examples, the additional camera parameters 25 can include focal length, principal point, skew, radial distortion, tangential distortion, and/or various camera intrinsics. The training image embedding 26 can be a generative embedding that has been assigned to the training image. In other implementations, only the training position 22 is provided as input.

In particular, core to the challenges presented by “in-the-wild” imagery is the concept of per-image color variation: while it is assumed that the 3-D geometry of a scene is identical between all images, less consistency is expected from color due to variations in lighting and camera settings such as exposure.

To resolve this issue, optionally, in some implementations, each image in the training set can be assigned a unique embedding

$${e}_{i}^{( g )} 26 .$$

These embeddings

$${\{ {e}_{i}^{( g )} \}}_{i = 1}^{N}$$

can be optimized over the course of training along with the model's parameters.

Referring still to FIG. 2, the machine-learned view synthesis model 24 can process the inputted data to generate opacity and color data 27. For example, in some implementations, the machine-learned view synthesis model 24 can generate only a single set of opacity and color data 27 or, in other implementations, can generate both a static set of opacity and color data for static content of the scene and a transient set of color and opacity data 27 for transient content of the scene.

As one example, differential opacity σ(x) and color c(x,d) 27 can be predicted by a multilayer perceptron (MLP) or other model (e.g., some other form of neural network or other machine-learned model, which can be referred to as a NeRF model) given a 3-D location x(t) and view direction d. In some implementations, the MLP or other model can be explicitly designed to ensure that view direction d does not affect differential opacity σ. For example, a base portion of the model can predict opacity from the location only while the color can be predicted from both the location and viewing angle/direction. Again, in some implementations, this MLP's inputs can optionally be augmented with embedding e^{(g)}, where e^{(g)} is the generative embedding corresponding to the image being rendered. Similar to view direction d, some example implementations can ensure that the generative embedding e^{(g)} does not affect differential opacity σ. By augmenting the MLP's input with embedding

$${e}_{i}^{( g )} ,$$

some example implementations of the proposed models are able to directly vary the color and lighting of a scene based on an image's identity without modifying its 3-D geometry.

At 28, a volume rendering technique can be performed to generate a synthetic pixel color from the opacity and color data 27. For example, for a single set of opacity and color data 27, the color of a synthetic pixel can, in some examples, be obtained by integrating along a ray emanating from the camera.

More generally, referring again to FIG. 2, a loss function 30 can evaluate a difference between the synthetic pixel color generated at 28 and the ground truth pixel color 32 of the existing training image. For example, a squared error between the pixel colors expressed in RGB or some other color scheme can be used. In some implementations, the loss functions described in the previous section can be used at 30 to generate NeRF models with improved robustness to distractors. See also, FIG. 4.

The loss function 30 can be backpropagated to train the machine-learned view synthesis model 24. In addition, optionally, in some implementations, the training image embedding 26, the training position 22, and/or the camera parameters 25 can be updated as well based on the loss function 30 (e.g., by continuing to backpropagate the loss through and past the model 24).

At test or inference time, the model 24 can be used to render the static geometry common to all photos in the training set. As one example, FIG. 3 shows an example use of the machine-learned view synthesis model after training. Specifically, a desired position 40 (e.g., location and orientation) for a synthetic image of the scene is provided. Optionally, desired camera parameters 42 and/or a desired generative embedding 44 can be provided as well.

The machine-learned view synthesis model 24 can process the inputs to generate opacity and color data 27 (e.g., single set of opacity and color data or both static and transient opacity and color data, or just static opacity and color data). Volume rendering 28 can be performed on the opacity and color data (e.g., only the static data) to generate a synthetic pixel color for the pixel of the synthetic image.

The process shown in FIG. 3 can be performed for each pixel of the synthetic image.

### Example Training Method

FIG. 4 depicts a flow chart diagram of an example method to perform training of a neural radiance field model according to example embodiments of the present disclosure.

At 402, a computer system can obtain a position within a three-dimensional space. For example, the position can be associated with a ground truth training image that depicts a scene from the position. For example, the position can correspond to a certain pixel location (e.g., (x,y) location) within the ground truth training image according to a ray casting technique.

At 404, the computer system can process data descriptive of the position with the neural radiance field model to generate a synthetic pixel color at a pixel location in a synthetic image that depicts the scene from the position;

At 406, the computer system can evaluate a loss function that compares the synthetic pixel color with a ground truth pixel color at the pixel location in a training image that depicts the scene from the position.

In some implementations, the loss function comprises an iteratively reweighted least-squares function that comprises a weighting function that assigns a final weight to a residual associated with the pixel location based at least in part on intermediate weights assigned to one or more neighboring pixel locations in a neighborhood surrounding the pixel location. In some implementations, the residual associated with the pixel location comprises the residual from a prior sequential iteration of the plurality of iterations. In some implementations, the weighting function assigns final weights that are binary.

More particularly, in some example implementations, evaluating the loss function at 406 can include some or all of the following operations.

At 408, the computing system can assign an intermediate weight to the pixel location and one or more neighboring pixel locations based on whether respective residuals associated with the pixel locations exceed a threshold value.

As an example, picking the 50% percentile as an example threshold for convenience (i.e., median), some example implementations assign an intermediate weight value as follows:

$$\tilde{ω} ( r ) = ϵ ( r ) \leq {T}_{ϵ} , {T}_{ϵ} = {Median}_{r} \{ ϵ ( r ) \} . \qquad ( 8 )$$

where \tilde{ω}(r) assigns an intermediate weight to pixel location r and ∈(r) is the residual for location r according to

$${ϵ}^{( t - 1 )} ( r ) = {‖ C ( r ; {θ}^{( t - 1 )} ) - {C}_{i} ( r ) ‖}_{2} \qquad ( 7 )$$

For example, the intermediate weight can be set equal to a first binary value (e.g., one) if the residual for the pixel location is less than or equal to a median for all pixel locations, and zero to a second binary value (e.g., zero) otherwise.

At 410, the computing system can apply a smoothing kernel to the intermediate weights to generate smoothed weights. As an example, some example implementations optionally further spatially diffuse inlier/outlier labels with a smoothing kernel, such as, e.g., a 3×3 box kernel [symbol] _{3×3}. Formally, some example implementations assign smoothed weight values as follows:

$$𝒲 ( r ) = ( \tilde{ω} ( r ) \text{?} {ℬ}_{3 \times 3} ) \geq {T}_{\text{?}} , {T}_{\text{?}} = 0.5 . \qquad ( 9 )$$

where [symbol] (r) assigns smoothed weight values to the location r. For example, [symbol] (r) can assign a first binary value (e.g., one) if the result of applying the box kernel is greater than or equal to a second threshold value; and can assign a second binary value (e.g., zero) otherwise. T_{\textcircled{*}}=0.5 is just one example of the second threshold value; other values can be used alternatively.

This tends to remove high-frequency details from being classified as outliers, allowing them to be captured by the NeRF model during optimization.

At 412, the computing system can assign a final weight to a patch of multiple pixel locations that includes the pixel location based at least in part on the smoothed weights associated with the one or more neighboring pixels.

As one example, some example implementations aggregate the detection of outliers on 16×16 neighborhoods (other sizes can be used as well); e.g., some example implementations label entire 8×8 patches (other sizes can be used as well) as outliers or inliers based on the behavior of [symbol] in the 16×16 neighborhood of the patch. Formally, denoting the N×N neighborhood of pixels around r as [symbol] _{N}(r), some example implementations can assign a final weight value as follows:

$$ω ( {ℛ}_{8} ( r ) ) = {𝔼}_{s \sim {ℛ}_{16} ( r )} [ 𝒲 ( s ) ] \geq {T}_{ℛ} , {T}_{ℛ} = 0.6 . \qquad ( 10 )$$

where ω( [symbol] ₈(r)) assigns a final weight value to the patch [symbol] ₈(r). For example, ω( [symbol] ₈(r)) can assign a first binary value (e.g., one) if the expectation over the 16×16 neighborhood is greater than or equal to a third threshold value; and can assign a second binary value (e.g., zero) otherwise. T [symbol] =0.6 is just one example of the third threshold value; other values can be used alternatively. 8×8 and 16×16 are also provided as examples only, other spatial dimensions can be used as alternatively.

At 414, the computing system can determine a current loss value for the pixel location based on the final weight and a distance between the synthetic pixel color and the ground truth pixel color. As an example, some example implementations can determine the current loss value as follows:

$${ℒ}_{robust}^{r , i} ( θ ) = ω ( {ℛ}_{8} ( r ) ) \cdot {‖ C ( r ; {θ}^{( t )} ) - {C}_{i} ( r ) ‖}_{2}^{2}$$

where

$${‖ C ( r ; {θ}^{( t )} ) - {C}_{i} ( r ) ‖}_{2}^{2}$$

is an L2 distance between the synthetic pixel color C(r; θ^{(t)}) and the ground truth pixel color Cᵢ(r).

Referring again to FIG. 4, at 416, the computing system can modify one or more parameter values for one or more parameters of the neural radiance field model based at least in part on the loss function.

After 416, the method can optionally return to 402 and begin again with the same position in the same training image, a different position in the same training image, or a different position in a different training image. The method can be repeated until convergence or until some stopping condition is met.

### Example Devices and Systems

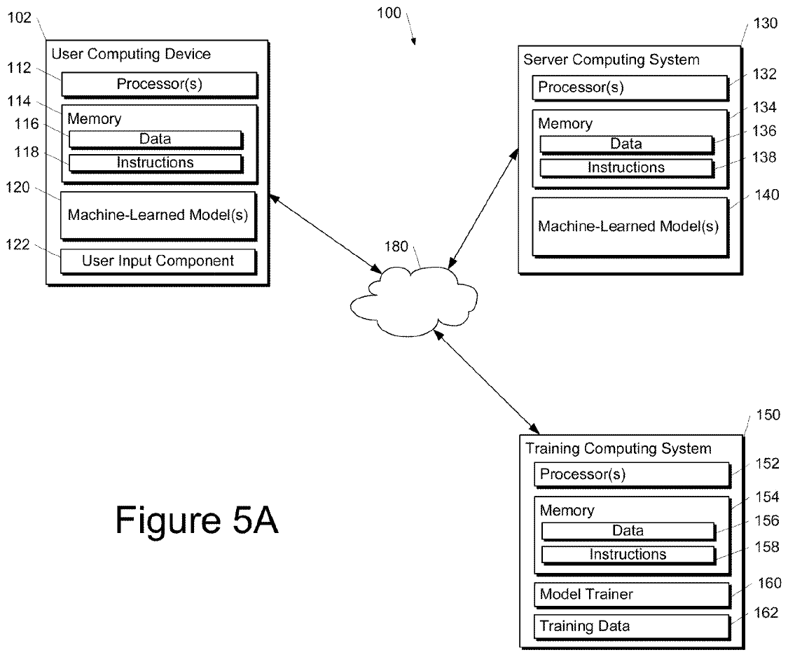

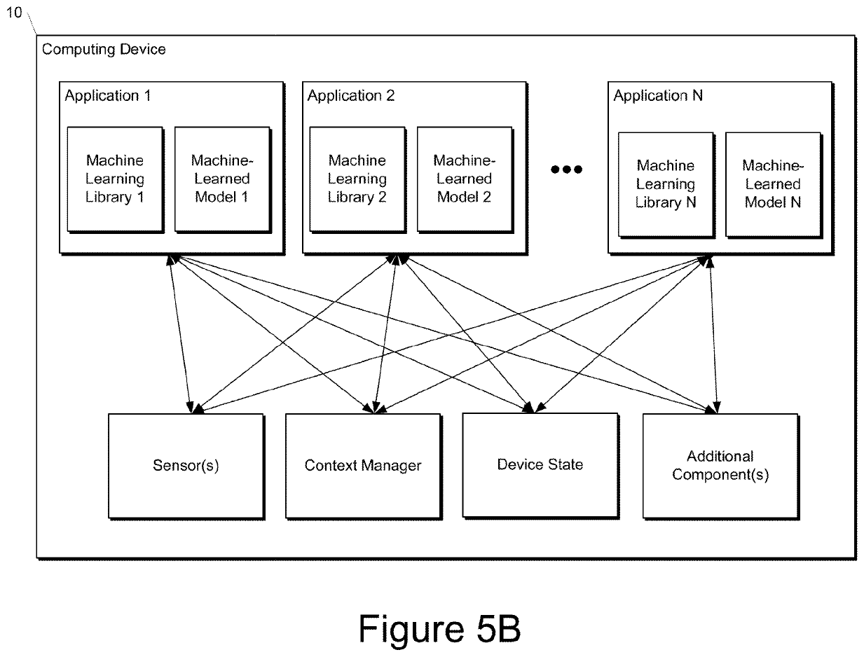

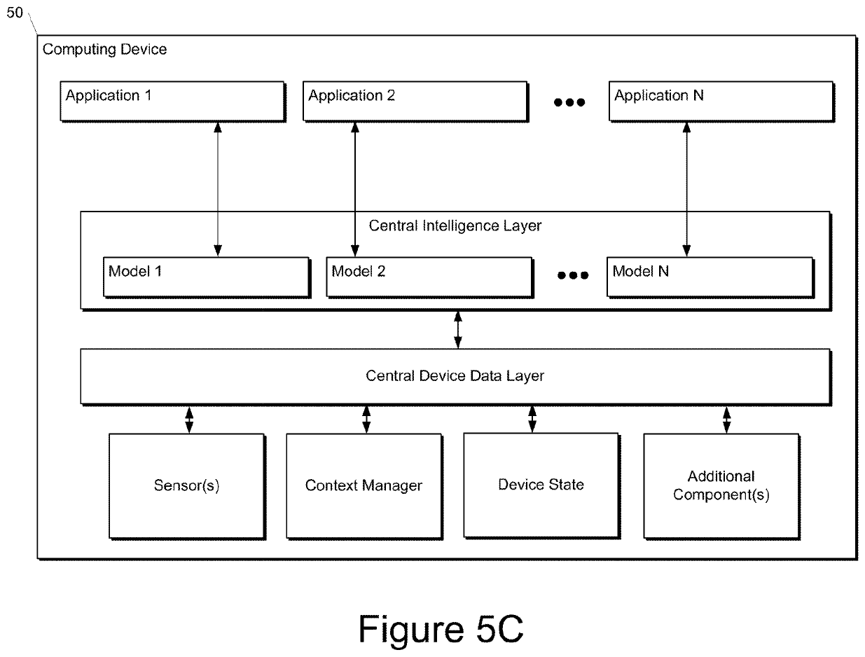

FIG. 5A depicts a block diagram of an example computing system 100 according to example embodiments of the present disclosure. The system 100 includes a user computing device 102, a server computing system 130, and a training computing system 150 that are communicatively coupled over a network 180.

The user computing device 102 can be any type of computing device, such as, for example, a personal computing device (e.g., laptop or desktop), a mobile computing device (e.g., smartphone or tablet), a gaming console or controller, a wearable computing device, an embedded computing device, or any other type of computing device.

The user computing device 102 includes one or more processors 112 and a memory 114. The one or more processors 112 can be any suitable processing device (e.g., a processor core, a microprocessor, an ASIC, a FPGA, a controller, a microcontroller, etc.) and can be one processor or a plurality of processors that are operatively connected. The memory 114 can include one or more non-transitory computer-readable storage mediums, such as RAM, ROM, EEPROM, EPROM, flash memory devices, magnetic disks, etc., and combinations thereof. The memory 114 can store data 116 and instructions 118 which are executed by the processor 112 to cause the user computing device 102 to perform operations.

In some implementations, the user computing device 102 can store or include one or more machine-learned models 120. For example, the machine-learned models 120 can be or can otherwise include various machine-learned models such as neural networks (e.g., deep neural networks) or other types of machine-learned models, including non-linear models and/or linear models. Neural networks can include feed-forward neural networks, recurrent neural networks (e.g., long short-term memory recurrent neural networks), convolutional neural networks or other forms of neural networks. Example machine-learned models 120 are discussed with reference to FIGS. 1-4.

In some implementations, the one or more machine-learned models 120 can be received from the server computing system 130 over network 180, stored in the user computing device memory 114, and then used or otherwise implemented by the one or more processors 112. In some implementations, the user computing device 102 can implement multiple parallel instances of a single machine-learned model 120 (e.g., to perform parallel view synthesis across multiple instances of the same or different scenes).

Additionally or alternatively, one or more machine-learned models 140 can be included in or otherwise stored and implemented by the server computing system 130 that communicates with the user computing device 102 according to a client-server relationship. For example, the machine-learned models 140 can be implemented by the server computing system 140 as a portion of a web service (e.g., a view synthesis service). Thus, one or more models 120 can be stored and implemented at the user computing device 102 and/or one or more models 140 can be stored and implemented at the server computing system 130.

The user computing device 102 can also include one or more user input component 122 that receives user input. For example, the user input component 122 can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, a traditional keyboard, or other means by which a user can provide user input.

The server computing system 130 includes one or more processors 132 and a memory 134. The one or more processors 132 can be any suitable processing device (e.g., a processor core, a microprocessor, an ASIC, a FPGA, a controller, a microcontroller, etc.) and can be one processor or a plurality of processors that are operatively connected. The memory 134 can include one or more non-transitory computer-readable storage mediums, such as RAM, ROM, EEPROM, EPROM, flash memory devices, magnetic disks, etc., and combinations thereof. The memory 134 can store data 136 and instructions 138 which are executed by the processor 132 to cause the server computing system 130 to perform operations.

In some implementations, the server computing system 130 includes or is otherwise implemented by one or more server computing devices. In instances in which the server computing system 130 includes plural server computing devices, such server computing devices can operate according to sequential computing architectures, parallel computing architectures, or some combination thereof.

As described above, the server computing system 130 can store or otherwise include one or more machine-learned models 140. For example, the models 140 can be or can otherwise include various machine-learned models. Example machine-learned models include neural networks or other multi-layer non-linear models. Example neural networks include feed forward neural networks, deep neural networks, recurrent neural networks, and convolutional neural networks. Example models 140 are discussed with reference to FIGS. 1-4.

The user computing device 102 and/or the server computing system 130 can train the models 120 and/or 140 via interaction with the training computing system 150 that is communicatively coupled over the network 180. The training computing system 150 can be separate from the server computing system 130 or can be a portion of the server computing system 130.

The training computing system 150 includes one or more processors 152 and a memory 154. The one or more processors 152 can be any suitable processing device (e.g., a processor core, a microprocessor, an ASIC, a FPGA, a controller, a microcontroller, etc.) and can be one processor or a plurality of processors that are operatively connected. The memory 154 can include one or more non-transitory computer-readable storage mediums, such as RAM, ROM, EEPROM, EPROM, flash memory devices, magnetic disks, etc., and combinations thereof. The memory 154 can store data 156 and instructions 158 which are executed by the processor 152 to cause the training computing system 150 to perform operations. In some implementations, the training computing system 150 includes or is otherwise implemented by one or more server computing devices.

The training computing system 150 can include a model trainer 160 that trains the machine-learned models 120 and/or 140 stored at the user computing device 102 and/or the server computing system 130 using various training or learning techniques, such as, for example, backwards propagation of errors. For example, a loss function can be backpropagated through the model(s) to update one or more parameters of the model(s) (e.g., based on a gradient of the loss function). Various loss functions can be used such as mean squared error, likelihood loss, cross entropy loss, hinge loss, and/or various other loss functions. Gradient descent techniques can be used to iteratively update the parameters over a number of training iterations.

In some implementations, performing backwards propagation of errors can include performing truncated backpropagation through time. The model trainer 160 can perform a number of generalization techniques (e.g., weight decays, dropouts, etc.) to improve the generalization capability of the models being trained.

In particular, the model trainer 160 can train the machine-learned models 120 and/or 140 based on a set of training data 162. The training data 162 can include, for example, unconstrained image data such as “in the wild” photographs.

In some implementations, if the user has provided consent, the training examples can be provided by the user computing device 102. Thus, in such implementations, the model 120 provided to the user computing device 102 can be trained by the training computing system 150 on user-specific data received from the user computing device 102. In some instances, this process can be referred to as personalizing the model.

The model trainer 160 includes computer logic utilized to provide desired functionality. The model trainer 160 can be implemented in hardware, firmware, and/or software controlling a general purpose processor. For example, in some implementations, the model trainer 160 includes program files stored on a storage device, loaded into a memory and executed by one or more processors. In other implementations, the model trainer 160 includes one or more sets of computer-executable instructions that are stored in a tangible computer-readable storage medium such as RAM hard disk or optical or magnetic media.

The network 180 can be any type of communications network, such as a local area network (e.g., intranet), wide area network (e.g., Internet), or some combination thereof and can include any number of wired or wireless links. In general, communication over the network 180 can be carried via any type of wired and/or wireless connection, using a wide variety of communication protocols (e.g., TCP/IP, HTTP, SMTP, FTP), encodings or formats (e.g., HTML, XML), and/or protection schemes (e.g., VPN, secure HTTP, SSL).

FIG. 5A illustrates one example computing system that can be used to implement the present disclosure. Other computing systems can be used as well. For example, in some implementations, the user computing device 102 can include the model trainer 160 and the training dataset 162. In such implementations, the models 120 can be both trained and used locally at the user computing device 102. In some of such implementations, the user computing device 102 can implement the model trainer 160 to personalize the models 120 based on user-specific data.

FIG. 5B depicts a block diagram of an example computing device 10 that performs according to example embodiments of the present disclosure. The computing device 10 can be a user computing device or a server computing device.

The computing device 10 includes a number of applications (e.g., applications 1 through N). Each application contains its own machine learning library and machine-learned model(s). For example, each application can include a machine-learned model. Example applications include a text messaging application, an email application, a dictation application, a virtual keyboard application, a browser application, etc.

As illustrated in FIG. 5B, each application can communicate with a number of other components of the computing device, such as, for example, one or more sensors, a context manager, a device state component, and/or additional components. In some implementations, each application can communicate with each device component using an API (e.g., a public API). In some implementations, the API used by each application is specific to that application.

FIG. 5C depicts a block diagram of an example computing device 50 that performs according to example embodiments of the present disclosure. The computing device 50 can be a user computing device or a server computing device.

The computing device 50 includes a number of applications (e.g., applications 1 through N). Each application is in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer includes a number of machine-learned models. For example, as illustrated in FIG. 5C, a respective machine-learned model (e.g., a model) can be provided for each application and managed by the central intelligence layer. In other implementations, two or more applications can share a single machine-learned model. For example, in some implementations, the central intelligence layer can provide a single model (e.g., a single model) for all of the applications. In some implementations, the central intelligence layer is included within or otherwise implemented by an operating system of the computing device 50.

The central intelligence layer can communicate with a central device data layer. The central device data layer can be a centralized repository of data for the computing device 50. As illustrated in FIG. 5C, the central device data layer can communicate with a number of other components of the computing device, such as, for example, one or more sensors, a context manager, a device state component, and/or additional components. In some implementations, the central device data layer can communicate with each device component using an API (e.g., a private API). FIG. 1 depicts a block diagram of an example process for training a machine-learned view synthesis model and then using the machine-learned view synthesis model to perform view synthesis according to example embodiments of the present disclosure.

### ADDITIONAL DISCLOSURE

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method to train a neural radiance field model to generate synthetic imagery of a scene, the method comprising:
for each of one or more of a plurality of training iterations:
obtaining a position within three-dimensional space;
processing data descriptive of the position with the neural radiance field model to generate a synthetic pixel color at a pixel location in a synthetic image that depicts the scene from the position;
evaluating a loss function that compares the synthetic pixel color with a ground truth pixel color at the pixel location in a training image that depicts the scene from the position, wherein the loss function comprises an iteratively reweighted least-squares function that comprises a weighting function that assigns a final weight to a residual associated with the pixel location based at least in part on intermediate weights assigned to one or more neighboring pixel locations in a neighborhood surrounding the pixel location; and
modifying one or more parameter values for one or more parameters of the neural radiance field model based at least in part on the loss function.

2. The computer-implemented method of claim 1, wherein the weighting function assigns final weights that are binary.

3. The computer-implemented method of claim 1, wherein the residual associated with the pixel location comprises the residual from a prior sequential iteration of the plurality of iterations.

4. The computer-implemented method of claim 1, wherein the weighting function:
assigns binary intermediate weights to the one or more neighboring pixel locations based on whether respective residuals associated with the neighboring pixel locations exceed a threshold value.

5. The computer-implemented method of claim 1, wherein the weighting function further:
applies a smoothing kernel to the intermediate weights of the one or more neighboring pixel locations to generate smoothed weights.

6. The computer-implemented method of claim 4, wherein the weighting function further:
assigns the final weight to a patch of multiple pixel locations that includes the pixel location based at least in part on the intermediate weights or smoothed weights associated with the one or more neighboring pixel locations.

7. The computer-implemented method of claim 4, wherein the threshold value comprises a median residual value for the synthetic image.

8. The computer-implemented method of any claim 5, wherein the smoothing kernel comprises a 3×3 box kernel.

9. The computer-implemented method of any claim 6, wherein the patch of multiple pixel locations comprises an 8×8 patch centered on the pixel location.

10. The computer-implemented method of claim 6, wherein the weighting function assigns the final weight to the patch of multiple pixel locations based on whether an expectation over the one or more neighboring pixel locations exceeds a second threshold value.

11. The computer-implemented method of claim 1, wherein the one or more neighboring pixel locations comprise a 16×16 neighborhood centered on the pixel location.

12. The computer-implemented method of claim 1, wherein evaluating the loss function comprises determining a current loss value for the pixel location based on the final weight and a distance between the synthetic pixel color and the ground truth pixel color.

13. The computer-implemented method of claim 1, wherein the neural radiance field model comprises a neural network.

14. A computing system configured to perform operations, the operations comprising:
for each of one or more of a plurality of training iterations:
obtaining a position within three-dimensional space;
processing data descriptive of the position with a neural radiance field model to generate a synthetic pixel color at a pixel location in a synthetic image that depicts the scene from the position;
evaluating a loss function that compares the synthetic pixel color with a ground truth pixel color at the pixel location in a training image that depicts the scene from the position, wherein the loss function comprises an iteratively reweighted least-squares function that comprises a weighting function that assigns a final weight to a residual associated with the pixel location based at least in part on intermediate weights assigned to one or more neighboring pixel locations in a neighborhood surrounding the pixel location; and
modifying one or more parameter values for one or more parameters of the neural radiance field model based at least in part on the loss function.

15. One or more non-transitory computer-readable media that store:
a neural radiance field model that has been trained by performance of training operations, the training operations comprising, for each of one or more of a plurality of training iterations;
obtaining a position within three-dimensional space;
processing data descriptive of the position with the neural radiance field model to generate a synthetic pixel color at a pixel location in a synthetic image that depicts the scene from the position;
evaluating a loss function that compares the synthetic pixel color with a ground truth pixel color at the pixel location in a training image that depicts the scene from the position, wherein the loss function comprises an iteratively reweighted least-squares function that comprises a weighting function that assigns a final weight to a residual associated with the pixel location based at least in part on intermediate weights assigned to one or more neighboring pixel locations in a neighborhood surrounding the pixel location; and
modifying one or more parameter values for one or more parameters of the neural radiance field model based at least in part on the loss function.
